(19) United States
(12) Patent Application Publication
(10) Pub. No.: US 2012/0081823 A1
(43) Pub. Date: Apr. 5, 2012

(54) PROTECTION CIRCUIT OF SEMICONDUCTOR APPARATUS

(75) Inventor: Shin Ho CHU, Icheon-si (KR)

(73) Assignee: HYNIX SEMICONDUCTOR INC., Icheon-si (KR)

(21) Appl. No.: 13/217,348

(22) Filed: Aug. 25, 2011

(30) Foreign Application Priority Data
Sep. 30, 2010 (KR) 10-2010-0095667

(51) Int. Cl. H02H 9/04

(52) U.S. Cl. 361/86

(57) ABSTRACT

An internal circuit protection circuit includes a voltage comparison unit and an internal circuit protection unit. The voltage comparison unit is configured to compare an external driving voltage applied from outside with a reference clamp voltage and output a comparison signal. The internal circuit protection unit is configured to adjust a level of the external driving voltage to a lower level than that of the reference clamp voltage, in response to the comparison signal.

### CROSS-REFERENCES TO RELATED APPLICATION

The present application claims priority under 35 U.S.C. §119(a) to Korean application number 10-2010-0095667, filed on, Sep. 30, 2010, in the Korean Intellectual Property Office, which is incorporated herein by reference in its entirety as set forth in full.

### BACKGROUND

1. Technical Field

The present invention generally relates to a semiconductor integrated circuit, and more particularly, to a protection circuit of a semiconductor apparatus.

2. Related Art

In general, a semiconductor apparatus receives an external driving voltage from outside and changes the voltage level of the received voltage into an internal driving level, in order to drive an internal circuit.

However, while the external driving voltage is applied to the internal circuit, a surge may occur. At this time, the external driving voltage needs to be clamped. Therefore, the semiconductor apparatus includes a protection circuit positioned between an input/output pad and the internal circuit, in order to prevent the internal circuit from being damaged from the surge.

Meanwhile, as the size of the semiconductor apparatus decreases, and as the speed of the semiconductor apparatus becomes faster, the thickness of gate oxide layers of transistors composing an internal circuit is gradually decreasing.

Therefore, the importance of the protection circuit for an internal element of the semiconductor apparatus is growing bigger.

### SUMMARY

In one embodiment of the present invention, a protection circuit of a semiconductor apparatus includes: a voltage comparison unit configured to compare an external driving voltage applied from outside with a reference clamp voltage and output a comparison signal; and an internal circuit protection unit configured to set a level of the external driving voltage to a lower level than that of the reference clamp voltage, in response to the comparison signal.

In another embodiment of the present invention, a protection circuit of an internal circuit includes: a voltage division unit configured to divide an external driving voltage applied from outside into an external driving voltage having ½ level; a voltage comparison unit configured to compare the external driving voltage applied from the voltage division unit and having ½ level with a reference clamp voltage having ½ level and output a comparison signal; and an internal circuit protection unit configured to control the amount of current to be discharged to the outside, in response to the comparison signal.

In another embodiment of the present invention, a protection circuit of an internal circuit includes: a voltage division unit configured to divide an external driving voltage applied from outside into an external driving voltage having 1/n level; a voltage comparison unit configured to compare the external driving voltage applied from the voltage division unit and having 1/n level with a reference clamp voltage having 1/n level and output a comparison signal; and an internal circuit protection unit configured to set a level of the external driving voltage to a lower level than that of the reference clamp voltage, in response to the comparison signal.

In another embodiment of the present invention, a protection circuit of a semiconductor apparatus includes: a voltage comparison unit configured to compare an external driving voltage applied from outside with a reference clamp voltage and output a comparison signal; and an internal circuit protection unit configured is to control the amount of current to be discharged to the outside, in response to the comparison signal.

### BRIEF DESCRIPTION OF THE DRAWINGS

Features, aspects, and embodiments are described in conjunction with the attached drawings, in which:

FIG. 1 is a block diagram of a protection circuit of a semiconductor apparatus according to one embodiment;

FIG. 2 is a detailed circuit diagram of the protection circuit of the semiconductor apparatus according to the embodiment;

FIG. 3 is a block diagram of a protection circuit of a semiconductor apparatus according to another embodiment;

FIG. 4 is a detailed circuit diagram of the protection circuit of the semiconductor apparatus according to the embodiment;

FIG. 5 is a detailed circuit diagram of a voltage division unit of FIG. 4;

FIG. 6 is a block diagram of a protection circuit of a semiconductor apparatus according to another embodiment;

FIG. 7 is a detailed circuit diagram of the protection circuit of the semiconductor apparatus according to the embodiment; and

FIG. 8 is a detailed circuit diagram of a voltage division unit of FIG. 7.

### DETAILED DESCRIPTION

Hereinafter, a protection circuit of a semiconductor is apparatus according to the present invention will be described below with reference to the accompanying drawings through exemplary embodiments.

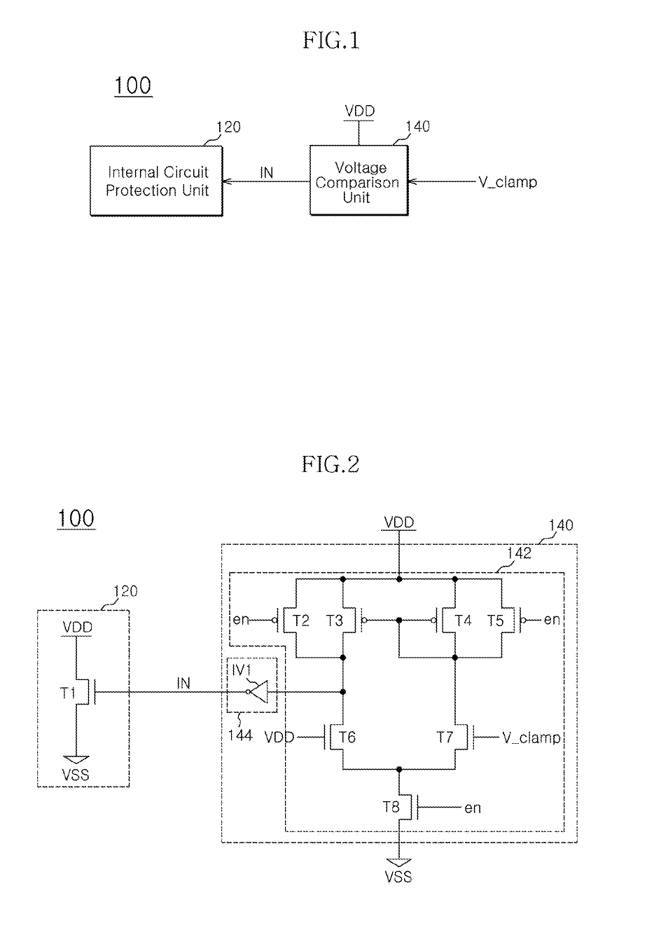

FIG. 1 is a block diagram of a protection circuit of a semiconductor apparatus according to one embodiment. FIG. 2 is a detailed circuit diagram of the protection circuit of the semiconductor apparatus according to the embodiment.

Referring to FIGS. 1 and 2, the protection circuit 100 of the semiconductor apparatus according to the embodiment includes a voltage comparison unit 140 and an internal circuit protection unit 120.

The voltage comparison unit 140 is configured to compare the voltage level of an external driving voltage VDD applied from outside with that of a reference clamp voltage V_clamp, and output a comparison signal IN having a level corresponding to the comparison result. At this time, for example, if the external driving voltage VDD is higher than the reference clamp voltage V_clamp, the comparison signal IN is activated to a high level.

The voltage comparison unit 140 includes a comparison section 142.

Referring to FIG. 2, the comparison section 142 includes first to fourth mirror transistors T2 to T5, first and second input transistors T6 and T7, and a sink transistor T8. The first to fourth mirror transistors T2 to T5 are coupled to an external driving voltage terminal VDD to form a current mirror. The first and second input is transistors T6 and T7 are configured to form a differential pair. The sink transistor T8 serves as a current source.

The operation of the comparison section 142 is performed as follows. The comparison section 142 receives the external driving voltage VDD applied from outside and the reference clamp voltage V_clamp through the first and second input transistors T6 and T7, respectively.

The voltage comparison unit 140 compares the external driving voltage VDD and the reference clamp voltage V_clamp applied through the first and second input transistors T6 and T7, respectively.

As a result of the comparison, when the external driving voltage VDD is higher than the reference clamp voltage V_clamp, the voltage comparison unit 140 outputs a comparison signal IN in a high level, through an output terminal thereof.

On the other hand, when the external driving voltage VDD is lower than the reference clamp voltage V_clamp, the voltage comparison unit 140 outputs a comparison signal IN in a low level, through the output terminal thereof.

Here, the protection circuit of the semiconductor apparatus according to the embodiment further includes an inversion section 144 configured to invert an output from the comparison section 142 and transmit the inverted output to the internal circuit protection unit 120. Referring to FIG. 2, the inversion section 144 is coupled to the output terminal of the comparison section 142, and may include an inverter, for example.

The internal circuit protection unit 120 may protect an internal circuit by controlling the amount of current to be discharged to the outside in response to the comparison signal IN outputted from the voltage comparison unit 140.

Referring to FIG. 2, the internal circuit protection unit 120 includes an NMOS transistor T1 coupled between a supply voltage terminal VDD and a ground voltage terminal VSS. Here, a gate terminal of the NMOS transistor T1 is coupled to an output terminal of the inversion section 144, and, according to an example, a source terminal of the NMOS transistor T1 is electrically coupled to a body of the NMOS transistor T1.

The operation of the internal circuit protection unit 120 is performed as follows. The internal circuit protection unit 120 discharges current to the outside based on the comparison signal IN outputted from the voltage comparison unit 140 and reduces the level of the external driving voltage VDD to such a level that has no effect upon the internal element, thereby protecting the internal circuit.

More specifically, when a high-level signal is applied from the voltage comparison unit 140, the internal circuit protection unit 120 is turned on to discharge current to the outside. On the other hand, when a low-level signal is applied from the voltage comparison unit 140, the internal circuit protection unit 120 is turned off to maintain the level of the external driving voltage.

As such, the protection circuit 100 of the semiconductor is apparatus according to the embodiment compares the level of the external driving voltage VDD applied from outside with that of the reference clamp voltage V_clamp, and outputs a corresponding signal according to the comparison result. Then, the internal circuit protection unit 120 controls the amount of current to be discharged, in response to the inputted comparison signal IN. Accordingly, the protection circuit 100 of the semiconductor apparatus according to the embodiment adjusts the level of the external driving voltage VDD inputted to the internal circuit, thereby protecting the internal circuit.

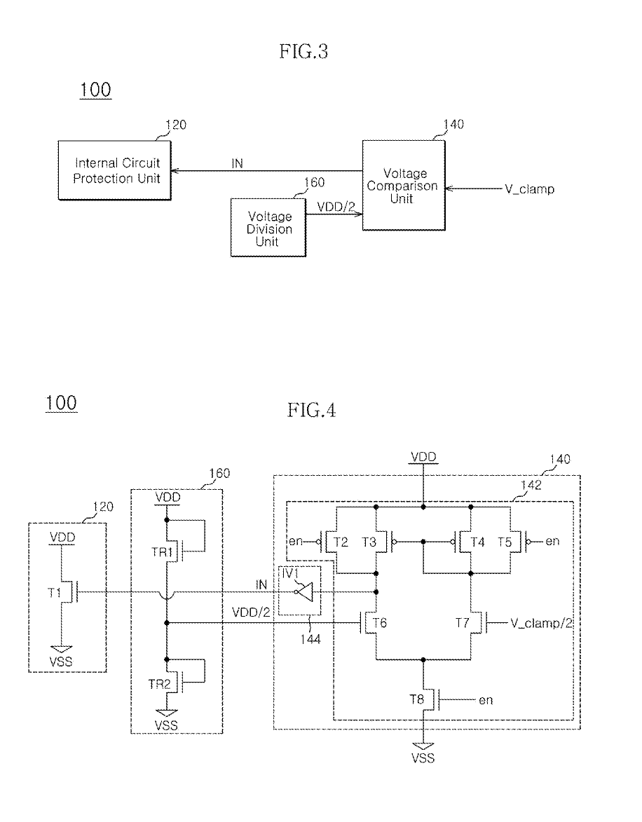

FIG. 3 is a block diagram of a protection circuit of a semiconductor apparatus according to another embodiment. FIG. 4 is a detailed circuit diagram of the protection circuit of the semiconductor apparatus according to the embodiment.

Referring to FIGS. 3 and 4, the protection circuit 100 according to the embodiment includes a voltage division unit 160, a voltage comparison unit 140, and an internal circuit protection unit 120.

The voltage division unit 160 is configured to divide the level of an external driving voltage VDD into ½.

Here, the reference clamp voltage V_clamp generated in the internal circuit is used as a reference voltage to regulate the external driving voltage VDD. However, the external driving voltage VDD is relatively high in comparison with voltages generated in the internal circuit. Therefore, according to an example, the level of the external driving voltage VDD is divided to set the level of the reference clamp is voltage V_clamp to such a level that is easily generated inside. Here, the level of the external driving voltage VDD is divided into ½, in order to provide the same condition as that of the reference clamp voltage V_clamp.

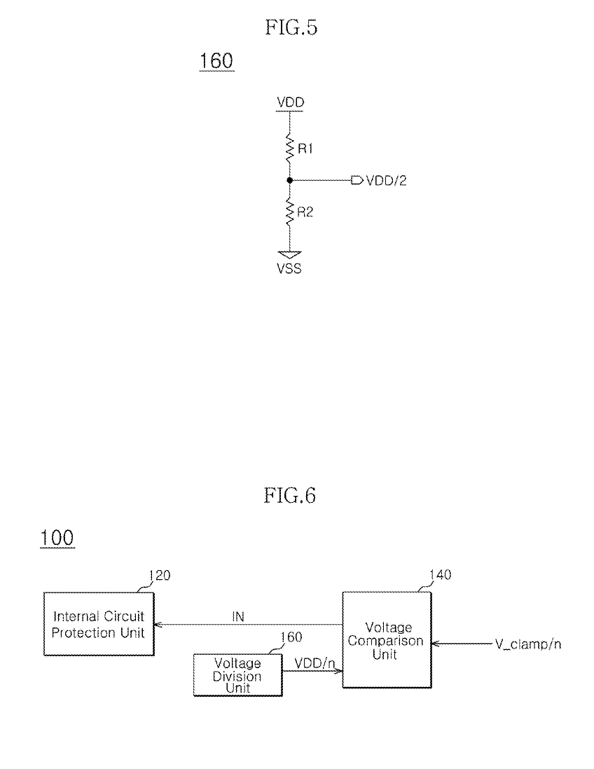

Referring to FIG. 4, the voltage division unit 160 includes two NMOS transistors TR1 and TR2 coupled in series between a supply voltage terminal VDD and a ground voltage terminal VSS and configured in a diode form. However, the voltage division unit 160 is not limited to the two NMOS transistors TR1 and TR2 as in the embodiment, and may include two resistors R1 and R2 as illustrated in FIG. 5.

In the case of the voltage division unit 160 includes two NMOS transistors TR1 and TR2, a signal having ½ level of the external driving voltage is outputted to the voltage comparison unit 140 through a node formed between the two NMOS transistors TR1 and TR2.

The voltage comparison unit 140 compares the voltage level of a reference clamp voltage V_clamp/2 having ½ level with that of the external diving voltage VDD/2 having ½ level, and outputs a comparison signal IN having a level corresponding to the comparison result. At this time, the comparison signal IN is activated to a high level. The voltage comparison unit 140 includes a comparison section 142.

Referring to FIG. 4, the comparison section 142 includes first to fourth mirror transistors T2 to T5, first and second input transistors T6 and T7, and a sink transistor T8. The first to fourth mirror transistors T2 to T5 are coupled to the external driving voltage terminal VDD to form a current mirror. The first and second input transistors T6 and T7 are configured to form a differential pair. The sink transistor T8 serves as a current source.

The operation of the voltage comparison unit 140 is performed as follows. The voltage comparison unit 140 receives the external driving voltage VDD/2 having ½ level applied from the voltage division unit 160 and the reference clamp voltage V_clamp/2 having ½ level through the first and second input transistors T6 and T7, respectively.

The voltage comparison unit 140 compares the external driving voltage VDD/2 having ½ level and the reference clamp voltage V_clamp/2 having ½ level, which are applied to the first and second input transistors T6 and T7, respectively.

As a result of the comparison, when the external driving voltage VDD/2 having ½ level is higher than the reference clamp voltage V_clamp/2 having ½ level, the voltage comparison unit 140 outputs a comparison signal IN in a high level, through an output terminal thereof.

On the other hand, when the external driving voltage VDD/2 having ½ level is lower than the reference clamp voltage V_clamp/2 having ½ level, the voltage comparison unit 140 outputs a comparison signal IN in a low level, through the output terminal thereof.

The protection circuit of the semiconductor apparatus according to the embodiment further includes an inversion section 144 configured to invert an output from the comparison section 142 and transmit the inverted output to the internal circuit protection unit 120. Referring to FIG. 4, the inversion section 144 is coupled to an output terminal of the comparison section 142, and may include an inverter, for example.

The internal circuit protection unit 120 may control the amount of current discharged to the outside in response to the comparison signal in outputted from the voltage comparison unit 140, thereby protecting an internal circuit.

Referring to FIG. 4, the internal circuit protection unit 120 includes an NMOS transistor T1 coupled between a supply voltage terminal VDD and a ground terminal VSS. Here, a gate terminal of the NMOS transistor T1 is coupled to an output terminal of the inverter formed at the output terminal of the voltage comparison unit 140, and, according to an example, a source terminal of the NMOS transistor T1 is electrically coupled to a body of the NMOS transistor T1.

The operation of the internal circuit protection unit 120 is performed as follows. The internal circuit protection unit 120 discharges current to the outside based on the comparison signal IN outputted from the voltage comparison unit 140, and reduces the level of the external driving voltage VDD to such a level that has no effect upon internal elements, thereby protecting the internal circuit.

More specifically, when a high-level signal is applied from the voltage comparison unit 140, the internal circuit protection unit 120 is turned on to discharge current to the outside. On the other hand, when a low-level signal is applied from the voltage comparison unit 140, the internal circuit protection unit 120 is turned off to maintain the level of the external driving voltage.

As such, the protection circuit 100 of the semiconductor apparatus according to the embodiment compares the level of the driving voltage VDD/2 applied from outside and having ½ level with that of the reference clamp voltage V_clamp/2 having ½ level, and outputs a corresponding signal according to the comparison result. Then, the internal circuit protection unit 120 controls the amount of current to be discharged, in response to the inputted comparison signal IN.

Furthermore, the levels of the external driving voltage and the reference clamp voltage may be set to such a level that is easily generated inside, which makes it possible to increase the reliability of the internal elements.

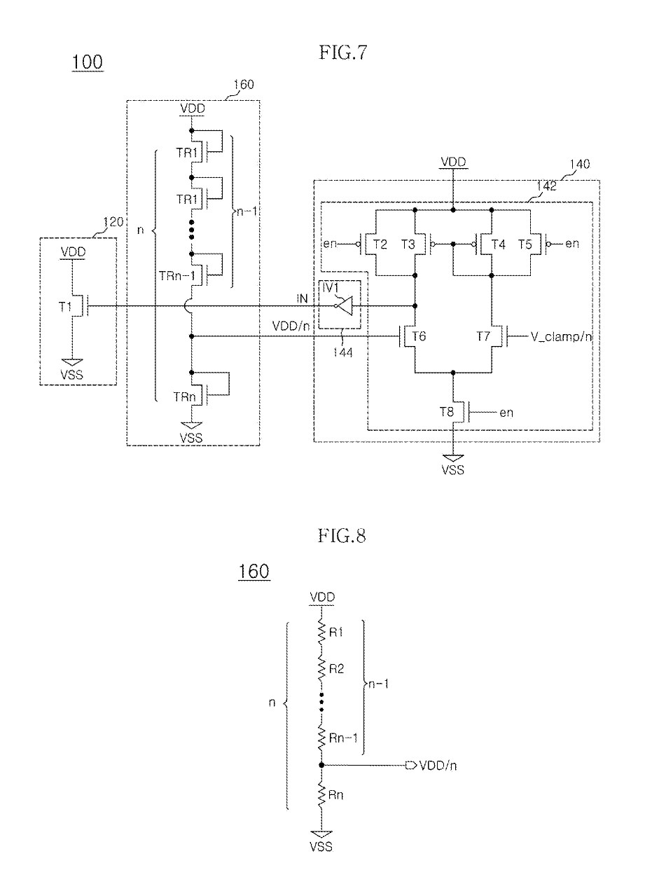

FIG. 6 is a block diagram of a protection circuit of a semiconductor apparatus according to another embodiment. FIG. 7 is a detailed circuit diagram of the protection circuit of the semiconductor apparatus according to the embodiment.

Referring to FIGS. 6 and 7, the protection circuit 100 of the semiconductor apparatus according to the embodiment includes a voltage division unit 160, a voltage comparison unit 140, and an internal circuit protection unit 120.

The voltage division unit 160 is configured to divide the level of an external driving voltage VDD into 1/n.

In FIG. 4, the voltage division unit 160 divides the level of the external driving voltage into ½. In this embodiment, however, the voltage division unit 160 may divide the level of the external driving voltage VDD into 1/n in proportion to an increase of the external driving voltage VDD.

Here, the reference clamp voltage V_clamp generated in the internal circuit is used as a reference voltage to regulate the external driving voltage VDD. However the external driving voltage VDD is relatively high in comparison with voltages generated in the internal circuit. Therefore, according to an example, the level of the external driving voltage VDD may be divided as low as possible, in order to set the level of the reference clamp voltage V_clamp to such a level that is easily generated inside.

Referring to FIG. 7, the voltage division unit 160 includes n NMOS transistors TR1 to TRn coupled in series between a supply voltage terminal VDD and a ground voltage terminal VSS. However, the voltage division unit 160 is not limited to the n NMOS transistors TR1 to TRn as in this embodiment, and may include n resistors R1 to Rn as illustrated in FIG. 8.

In the case of the voltage division unit 160 includes NMOS transistors TR1 to TRn, the external driving voltage VDD having 1/n level is inputted to the voltage comparison unit 140 through a node formed between the (n−1)th NMOS transistor TRn−1 and the nth NMOS transistor TRn. On the other hand, when the voltage division unit 160 includes n resistors, the external driving voltage VDD having 1/n level may be inputted to the voltage comparison unit 140 through the node formed between the (n−1)th resistor Rn−1 and the nth resistor Rn.

The voltage comparison unit 140 compares the level of a reference clamp voltage V_clamp/n applied from outside and having 1/n level with that of the external driving voltage VDD/n having 1/n level, and outputs a comparison signal in having a level corresponding to the comparison result. At this time, the comparison signal IN is activated to a high level. The comparison unit 140 includes a comparison section 142.

Referring to FIG. 7, the comparison section 142 includes first to fourth mirror transistors T2 to T5, first and second input transistors T6 and T7, and a sink transistor T8. The first to fourth mirror transistors T2 to T5 are coupled to the external driving voltage terminal VDD to form a current mirror. The first and second input transistors T6 and T7 are configured to form a differential pair. The sink transistor T8 serves as a current source.

The operation of the voltage comparison unit 140 is performed as follows. The voltage comparison 140 receives the external driving voltage VDD/n having 1/n level applied from the voltage division unit 160 and the reference clamp voltage V_clamp/n having 1/n through the first and second input transistors T6 and T7, is respectively.

The voltage comparison unit 140 compares the external driving voltage VDD/n having 1/n level and the reference clamp voltage V_clamp/n having 1/n level, which are applied to the first and second input transistors T6 and T7, respectively.

As a result of the comparison, when the external driving voltage VDD/n having 1/n level is higher than the reference voltage V_clamp/n having 1/n level, the voltage comparison unit 140 outputs a comparison signal IN in a high level, through an output terminal thereof.

On the other hand, when the external driving voltage VDD/n having 1/n level is lower than the reference voltage V_clamp/n having 1/n level, the voltage comparison unit 140 outputs a comparison signal IN in a low level, through the output terminal thereof.

Referring to FIG. 7, the internal circuit protection unit 120 includes an NMOS transistor T1 coupled between a supply voltage terminal VDD and a ground voltage terminal VSS. Here, a gate terminal of the NMOS transistor T1 is coupled to an output terminal of the inversion section 144, and, according to an example, a source terminal of the NMOS transistor T1 is electrically coupled to a body of the NMOS transistor T1.

The operation of the internal circuit protection unit 120 is performed as follows. The internal circuit protection unit 120 discharges current to the outside based on the comparison signal IN is outputted from the voltage comparison unit 140, and reduces the level of the external driving voltage VDD to such a level that has no effect upon internal elements, thereby protecting the internal circuit.

More specifically, when a high-level signal is applied from the voltage comparison unit 140, the internal circuit protection unit 120 is turned on to discharge current to the outside. On the other hand, when a low-level signal is applied from the voltage comparison unit 140, the internal circuit protection unit 120 is turned off to maintain the level of the external driving voltage.

As such, the protection circuit 100 of the semiconductor apparatus according to the embodiment compares the level of the driving voltage VDD/n applied from outside with that of the reference clamp voltage V_clamp/n, and outputs a corresponding signal according to the comparison result. Then, the internal circuit protection unit 120 controls the amount of current to be discharged, in response to the inputted comparison signal IN.

Furthermore, the levels of the external driving voltage and the reference clamp voltage may be set to such a level that is easily generated inside, which makes it possible to increase the reliability of the internal elements.

While certain embodiments have been described above, it will be understood to those skilled in the art that the embodiments described are by way of example only. Accordingly, the protection circuit described herein should not be limited based on the described embodiments. Rather, the protection circuit described herein should only be limited in light of the claims that follow when taken in conjunction with the above description and accompanying drawings.

What is claimed is:

1. A protection circuit of a semiconductor apparatus comprising:
a voltage comparison unit configured to compare an external driving voltage applied from outside with a reference clamp voltage and output a comparison signal; and
an internal circuit protection unit configured to adjust a level of the external driving voltage to a equal level to or lower level than that of the reference clamp voltage, in response to the comparison signal.

2. The protection circuit according to claim 1, wherein the voltage comparison unit activates the comparison signal when the is external driving voltage is higher than the reference clamp voltage, and deactivates the comparison signal when the external driving voltage is lower than the reference clamp voltage.

3. The protection circuit according to claim 2, wherein the internal circuit protection unit comprises an NMOS transistor coupled between a supply voltage terminal and a ground voltage terminal and wherein the NMOS transistor is configured to receive the comparison signal through a gate thereof.

4. The protection circuit according to claim 3, wherein, when the activated comparison signal is applied from the voltage comparison unit, the internal circuit protection unit is turned on to adjust the level of the external driving voltage to a equal level to or lower level than that of the reference clamp voltage.

5. The protection circuit of according to claim 4, wherein, when the deactivated comparison signal is applied from the voltage comparison unit, the internal circuit protection unit is turned off to maintain the level of the external driving voltage.

6. A protection circuit of an internal circuit comprising:
a voltage division unit configured to divide an external driving voltage applied from outside into an external driving voltage having ½ level;
is a voltage comparison unit configured to compare the external driving voltage, applied from the voltage division unit and having ½ level, with a reference clamp voltage having ½ level, and output a comparison signal; and
an internal circuit protection unit configured to control the amount of current to be discharged to the outside, in response to the comparison signal.

7. The protection circuit according to claim 6, wherein the voltage comparison unit activates the comparison signal when the external driving voltage having ½ level is higher than the reference clamp voltage having ½ level, and deactivates the comparison signal when the external driving voltage having ½ level is lower than the reference clamp voltage having ½ level.

8. The protection circuit according to claim 7, wherein the internal circuit protection unit comprises an NMOS transistor coupled between a supply voltage terminal and a ground voltage terminal and wherein the NMOS transistor is configured to receive the comparison signal through a gate thereof.

9. The protection circuit according to claim 8, wherein, when the activated comparison signal is applied from the voltage comparison unit, the internal circuit protection unit is turned on to discharge current to the outside.

10. The protection circuit according to claim 9, wherein, when the deactivated comparison signal is applied from the voltage comparison unit, the internal circuit protection unit is turned off.

11. A protection circuit of an internal circuit comprising:
a voltage division unit configured to divide an external driving voltage applied from outside into an external driving voltage having 1/n level;
a voltage comparison unit configured to compare the external driving voltage, applied from the voltage division unit and having 1/n level, with a reference clamp voltage having 1/n level, and output a comparison signal; and
an internal circuit protection unit configured to adjust a level of the external driving voltage to a equal level to or lower level than that of the reference clamp voltage, in response to the comparison signal.

12. The protection circuit according to claim 11, wherein the voltage comparison unit activates the comparison signal when the external driving voltage having 1/n level is higher than the reference clamp voltage having 1/n level, and deactivates the comparison signal when the external driving voltage having 1/n level is lower than the reference clamp voltage having 1/n level.

13. The protection circuit according to claim 12, wherein the internal circuit protection unit comprises an NMOS transistor coupled between a supply voltage terminal and a ground voltage terminal and wherein the NMOS transistor is configured to receive the comparison signal through a gate thereof.

14. The protection circuit according to claim 13, wherein, when the activated comparison signal is applied from the voltage comparison unit, the internal circuit protection unit is turned on to adjust the level of the external driving voltage to a equal level to or lower level than that of the reference clamp voltage.

15. The protection circuit according to claim 14, wherein, when the deactivated comparison signal is applied from the voltage comparison unit, the internal circuit protection unit is turned off to maintain the level of the external driving voltage.

16. A protection circuit of a semiconductor apparatus comprising:
a voltage comparison unit configured to compare an external driving voltage applied from outside with a reference clamp voltage and output a comparison signal; and
an internal circuit protection unit configured to control the amount of current to be discharged to the outside, in response to the comparison signal.

17. The protection circuit according to claim 16, further comprising a voltage division unit configured to divide the external driving voltage and transmit the divided external driving voltage to the voltage comparison unit,
wherein the external driving voltage applied to the voltage comparison unit has a level divided into 1/n by the voltage division unit.

18. The protection circuit according to claim 17, wherein the reference clamp voltage has a level divided into 1/n.
